(19) United States
(12) Patent Application Publication
(10) Pub. No.: US 2017/0083593 A1
(43) Pub. Date: Mar. 23, 2017

(54) VISUALIZATION TRANSFORMATION SERVER FOR BIG DATA

(71) Applicant: General Electric Company, Schenectady, NY (US)

(72) Inventors: Waqas Javed, San Ramon, CA (US); Karl Lewis Mochel, San Ramon, CA (US)

(21) Appl. No.: 14/859,986

(22) Filed: Sep. 21, 2015

(51) Int. Cl. G06F 17/30

(52) U.S. Cl. CPC G06F 17/30569; G06F 17/30572

(57) ABSTRACT

Some embodiments are associated with a big data non-relational database storing a substantial number of electronic files, including a set of values for a first parameter. A server may receive information from the big data non-relational database, and an initial transformation may be applied to the set of values for the first parameter resulting in a set of bucket containers, each bucket container storing information consolidating a plurality of values for the first parameter. A visualization transformation may then be applied to the bucket containers to create a set of pixel information to be transmitted to and rendered by a client platform.

### BACKGROUND

The invention relates generally to big data displays and more particularly to systems and methods to provide visualization of big data.

An enterprise may be able to access substantial amounts of data. For example, sensors associated with an industrial asset may continuously record values associated with a parameter (e.g., a temperature, speed, pressure, etc.). It can be difficult, however, for a person to look at the data and understand what the information means (e.g., a person looking at tens of thousands parameter values may find it difficult to identify trends or correlations within the data). Moreover, client platforms, such as personal computers executing browsers, smartphone applications, etc. may not be able to process extremely large quantities of data in a timely fashion. For example, Scalable Vector Graphics (“SVG”) approaches are not well suited to handle extremely large quantities of data. It would therefore be desirable to facilitate a visualization of big data in such a way so as to improve a person's ability to interpret the big data efficiently and/or accurately.

### BRIEF DESCRIPTION

Some embodiments are associated with a big data non-relational database storing a substantial number of electronic files, including a set of values for a first parameter. A server may receive information from the big data non-relational database, and an initial transformation may be applied to the set of values for the first parameter resulting in a set of bucket containers, each bucket container storing information consolidating a plurality of values for the first parameter. A visualization transformation may then be applied to the bucket containers to create a set of pixel information to be transmitted to and rendered by a client platform.

Some embodiments are associated with: means for accessing, via a big data non-relational database storing a substantial number of electronic files, a set of values for a first parameter; means for applying an initial transformation the set of values for the first parameter resulting in a set of bucket containers, each bucket container storing information consolidating a plurality of values for the first parameter; and means for applying a visualization transformation to the bucket containers to create a set of pixel information to be transmitted to and rendered by a client platform.

Other embodiments are associated with systems and/or computer-readable medium storing instructions to perform any of the methods described herein.

### DRAWINGS

FIG. 1 is a block diagram of a system that may be associated with any of the embodiments described herein.

FIG. 2 is a flow chart of a method in accordance with some embodiments.

FIG. 3 illustrates a web browser display in accordance with some embodiments.

FIG. 4 illustrates a tablet computer display in accordance with some embodiments.

FIGS. 5 through 7 are implementations in accordance with some embodiments.

FIG. 8 illustrates inverse transformations according to some embodiments.

FIG. 9 is an apparatus that may be provided in accordance with some embodiments.

FIG. 10 is a tabular view of a portion of a bucket containers and pixel information database in accordance with some embodiments of the present invention.

### DETAILED DESCRIPTION

Some embodiments disclosed herein facilitate a visualization of big data in such a way so as to improve a person's ability to interpret the big data efficiently and/or accurately. Some embodiments are associated with systems and/or computer-readable medium that may help perform such a method.

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

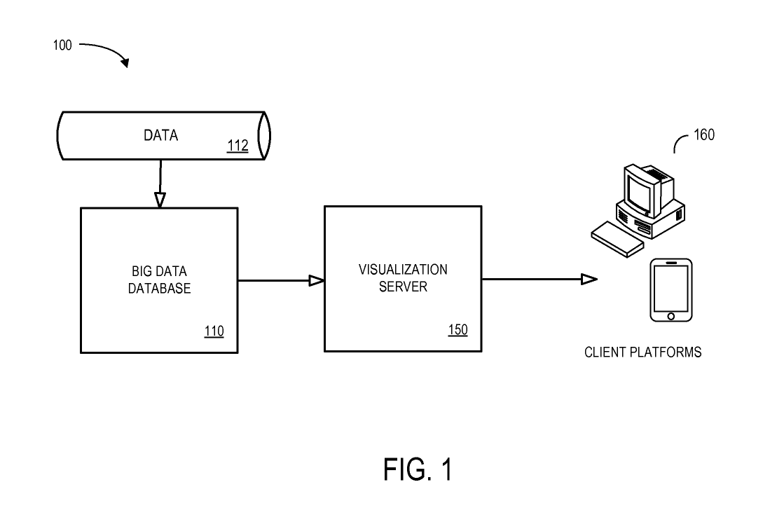

Some embodiments described herein may automatically facilitate a visualization of big data in such a way so as to improve a person's ability to interpret the data efficiency and/or accurately. For example, FIG. 1 is a block diagram of a system 100 that may be associated with any of the embodiments described herein. In particular, the system 100 includes a visualization server 150 that may access a big data database 110 in communication with a substantial amount of data 112. The big data database 110 may periodically update (e.g., on a daily basis) information about industrial assets, parameter values, metadata, etc. The visualization server 150 may also communicate with a set of client platforms 160 that are used to view information. The client platforms 160 may, for example, be used to execute a web browser, smartphone application, etc. According to some embodiments, the visualization server 150 may use a Graphical User Interface (“GUI”) to render user displays for the client platforms 160.

As used herein, the phrase “big data” may refer to data sets so large and/or complex that traditional data processing applications may be inadequate (e.g., to perform appropriate analysis, capture, data curation, search, sharing, storage, transfer, visualization, and/or information privacy for the data). Analysis of big data may lead to new correlations, to spot business trends, prevent diseases, etc. Scientists, business executives, practitioners of media and advertising and governments alike regularly meet difficulties with large data sets in areas including Internet search, finance and business informatics. Scientists encounter limitations in meteorology, genomics, complex physics simulations, biological and environmental research, etc.

Note that data sets may grow in size because they are increasingly gathered by cheap and/or numerous information-sensing mobile devices, aerial (remote sensing), software logs, cameras, microphones, Radio-Frequency Identification (“RFID”) readers, wireless sensor networks, etc.

Relational database management systems and desktop statistics and visualization packages may have difficulty handling big data. The work may instead be performed via parallel software running on multiple servers. Big data usually includes data sets with sizes beyond the ability of commonly used software tools to capture, curate, manage, and process data within a tolerable elapsed time. Some typical characteristics of big data include: Volume: big data doesn't sample. It just observes and tracks what happens; Velocity: big data is often available in real-time; Variety: big data draws from text, images, audio, video; plus it completes missing pieces through data fusion; Machine Learning: big data often doesn't ask why and simply detects patterns; and/or a digital footprint: big data is often a cost-free byproduct of digital interaction.

The visualization server 150 may provide information, such as user customized reports and/or displays based on information in the big data database 110. Note that a big data application might be associated with Hadoop, NoSQL, Watson, Mango, or any other appropriate program.

The visualization server 150 and/or other devices within the system 100 might be, for example, associated with a Personal Computer (“PC”), laptop computer, smartphone, an enterprise server, a server farm, and/or a database or similar storage devices. The visualization server 150 may, according to some embodiments, be associated with an industrial asset enterprise.

According to some embodiments, an “automated” visualization server 150 may facilitate the collection and analysis of big data. For example, the visualization server 150 may automatically customize a display based on the pixels and/or computational power of a client platform 160. As used herein, the term “automated” may refer to, for example, actions that can be performed with little (or no) intervention by a human.

As used herein, devices, including those associated with the visualization server 150 and any other device described herein may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The visualization server 150 may store information into and/or retrieve information from the big data database 110. The big data database 110 might be locally stored or reside remote from the visualization server 150. As will be described further below, the big data database 110 may be used by the visualization server 150 to facilitate interactions with users of client platforms 160. According to some embodiments, the visualization server 150 communicates information associated with big data to a remote device and/or to an automated system, such as by transmitting an electronic file to a user device, an email server, a workflow management system, a predictive model, a map application, etc.

Although a single visualization server 150 is shown in FIG. 1, any number of such devices may be included. Moreover, various devices described herein might be combined according to embodiments of the present invention. For example, in some embodiments, the visualization server 150 and big data database 110 might be co-located and/or may comprise a single apparatus.

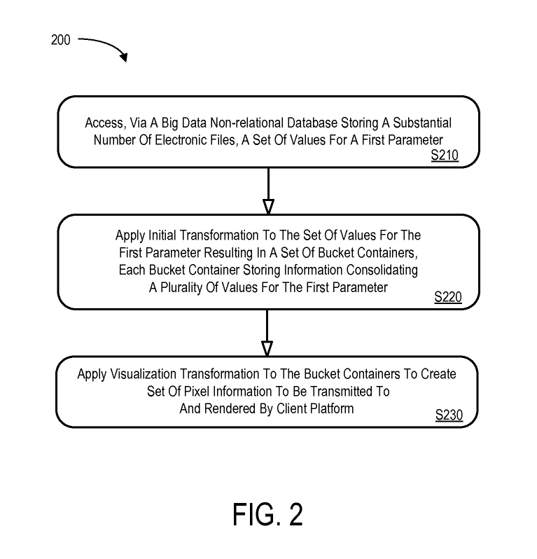

Note that the system 100 of FIG. 1 is provided only as an example, and embodiments may be associated with additional elements or components. According to some embodiments, the elements of the system 100 facilitate a visualization of big data in such a way so as to improve a person's ability to interpret the big data efficiently and/or accurately. Consider, for example, FIG. 2 which is a flow chart of a method 200 associated with a method in accordance with some embodiments. The flow charts described herein do not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

At S210, the system may access, via a big data non-relational database storing a substantial number of electronic files, a set of values for a first parameter. Note that the set of values for the first parameter in the big data non-relational database might be associated with, by way of example, an asset management program.

At S220, the system may apply an initial transformation the set of values for the first parameter resulting in a set of bucket containers, each bucket container storing information consolidating a plurality of values for the first parameter. Note that the number of bucket containers might be based at least in part on pixel information associated with the client platform. Further note that the initial transformation may be associated with at least one of: (i) a sampling function, (ii) an averaging function, (iii) a minimum value, (iv) a maximum value, and/or (v) a median value. According to some embodiments, at least some of the bucket containers may be processed asynchronously in parallel.

At S230, the system may apply a visualization transformation to the bucket containers to create a set of pixel information to be transmitted to and rendered by a client platform. According to some embodiments, the initial transformation and visualization transformation are performed at the big data non-relational database and the set of pixel information is stored at the big data non-relational database. According to other embodiments, the initial transformation is performed at the big data non-relational database and the visualization transformation is performed at the server. According to still other embodiments, the initial transformation and visualization transformation are performed at the server. Note that the pixel information might be associated with at least one of: (i) a heat map display, (ii) a scatter plot display, (iii) an X-Y axis graph, (iv) a pie chart, and/or (v) a bar graph display. According to some embodiments, visualization transformation is based on at least one of: (i) a user preference, and/or (ii) a context-based determination.

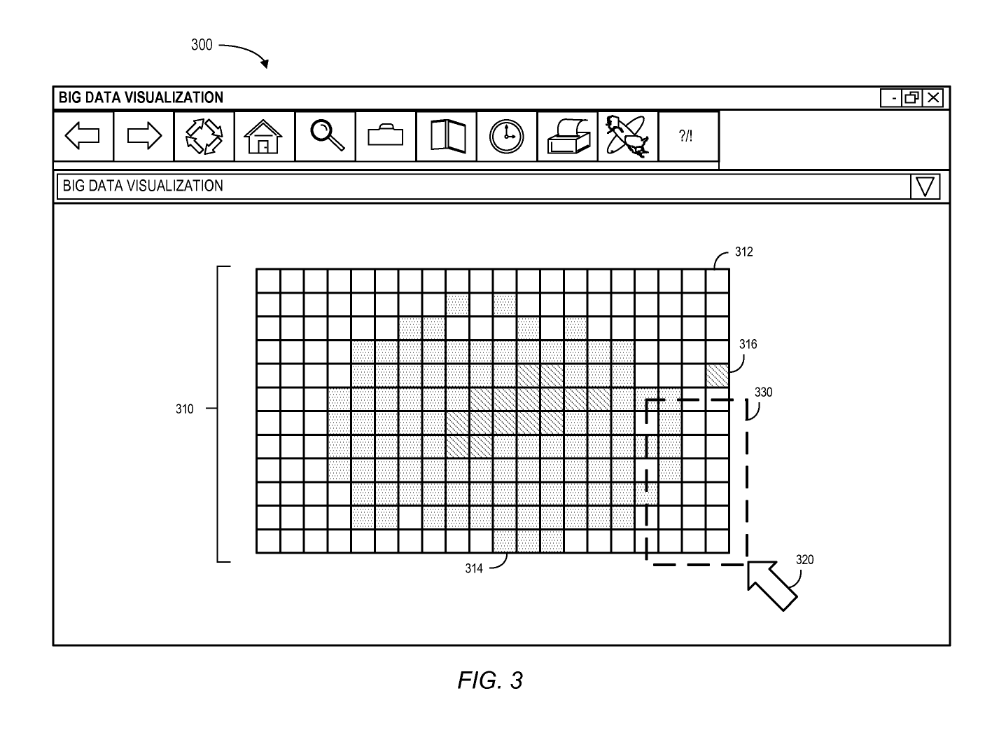

FIG. 3 illustrates a web browser display 300 in accordance with some embodiments. In particular, the web browser display 300 includes a heat map 310 visualization of big data. As used herein, the phrase “heat map” may refer to a graphical representation of data wherein individual values contained in a matrix are represented as colors or are otherwise distinguishable. For example, a first pixel type 312 (represented as white in FIG. 3) may represent a first parameter level, a second pixel type 314 (represented as dotted in FIG. 3) may represent a second parameter level, and a third pixel type 316 (represented as cross-hatched in FIG. 3) may represent a third parameter level. In this way, a user may be able to view the heat map 310 and detect patterns (e.g., groupings of similar parameter levels).

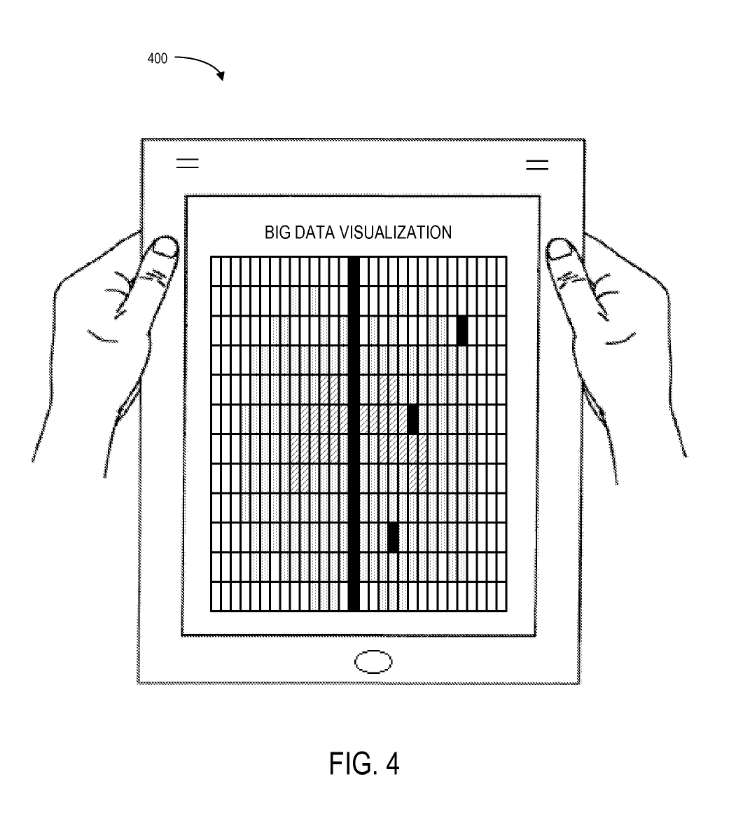

Similarly, FIG. 4 illustrates a tablet computer heat map display 400 in accordance with some embodiments. In this case, the visualization platform has aligned rows such that the first occurrence of a particular type of parameter value (indicated by solid black in FIG. 4) are each aligned at the center of the display 400. Such an approach may also help a user detect and/or understand correlations and/or relationships between the information in the display 400.

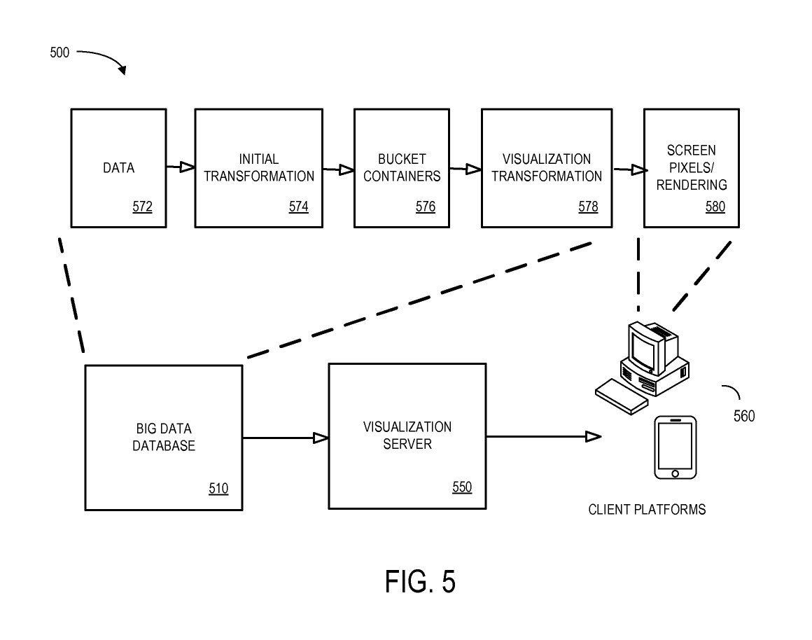

FIGS. 5 through 7 are implementations in accordance with some embodiments. As in FIG. 1, FIG. 5 illustrates an implementation 500 wherein information from a big data database 510 may be accessed by a visualization server 550 and used to render displays on client platforms 560. In this case, the big data server itself may access the data at 572, perform an initial transformation at 574, store the results of the initial transformation into bucket containers 576, and perform a visualization transformation at 578 on the bucket containers 576 to create screen pixels and/or rendering data that are displayed by the client platform at 580. That is, steps 572 though 578 may be performed at (and the associated information may be stored at) the big data database 510. The visualization server 550 would, in this embodiment, simply retrieve the information from the big data database 510 and forward it to the client platforms 560 for display.

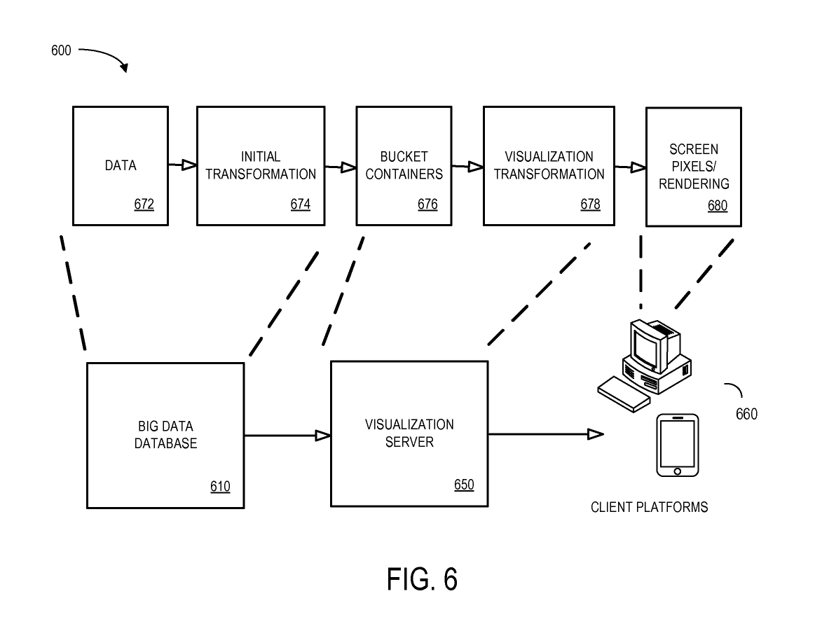

FIG. 6 illustrates an implementation 600 in accordance with another embodiment. As before, information from a big data database 610 may be accessed by a visualization server 650 and used to render displays on client platforms 660. In this case, the big data server itself may access the data at 672 and perform an initial transformation at 674. In this example, the visualization server 650 would store the results of the initial transformation into bucket containers 676 and perform a visualization transformation at 678 on the bucket containers 676 to create screen pixels and/or rendering data that are displayed by the client platform at 680. That is, steps 672 and 674 may be performed at (and the associated information may be stored at) the big data database 610 while steps 676 and 678 are performed at the visualization server 650. The visualization server 650 would, in this embodiment, retrieve the initial transformation information from the big data database 610, perform the visualization transformation at 678 and forward data to the client platforms 660 for display.

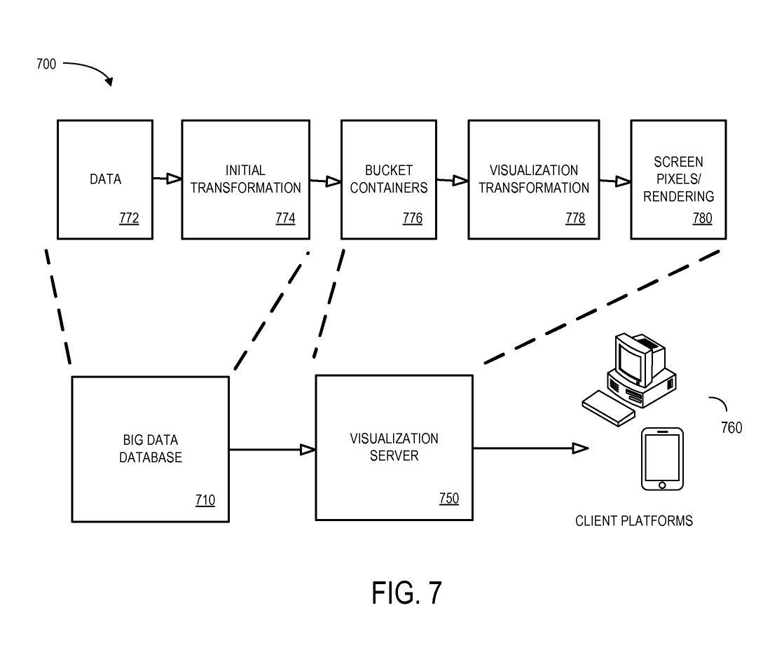

FIG. 7 illustrates an implementation 700 in accordance with yet another embodiment. As before, information from a big data database 710 may be accessed by a visualization server 750 and used to render displays on client platforms 760. In this case, the big data server itself may access the data at 772 and perform an initial transformation at 774. In this example, the visualization server 750 would store the results of the initial transformation into bucket containers 776 and perform a visualization transformation at 778 on the bucket containers 776 to create screen pixels and/or rendering data that are displayed by the client platform at 780. That is, steps 772 and 774 may be performed at (and the associated information may be stored at) the big data database 710 while steps 776, 778, and 780 are performed at the visualization server 750. The visualization server 750 would, in this embodiment, retrieve the initial transformation information from the big data database 710, perform the visualization transformation at 778 and forward data to the client platforms 760 for display. In this embodiment, the client platform 760 would simply receive the image to be display (and would not need to perform any processing at all).

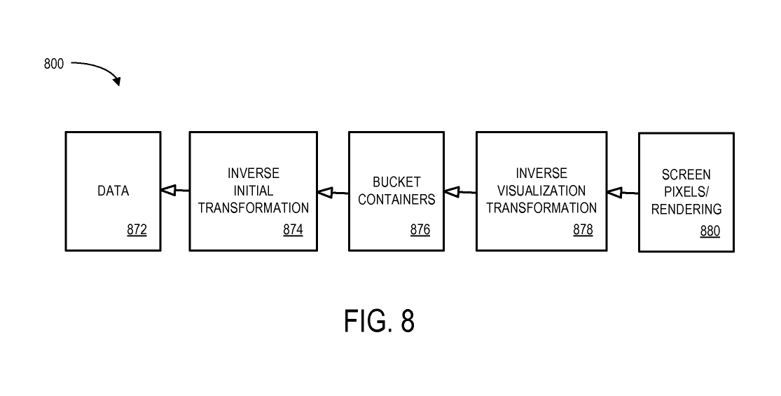

In some cases, a user might interact with a display at a client platform. For example, a user might select a portion of a display (e.g., when he or she is interested in viewing the big data values that resulted in that portion of the display). In the example of FIG. 3, a user might move a computer mouse pointer 320 to select an area 330 of the heat map display 310. In this case, the system might apply an inverse visualization transformation and inverse initial transformation to the at least one selected pixel to determine associated values in the big data non-relational database. FIG. 8 illustrates 800 inverse transformations according to some embodiments. In particular, the selected screen pixels and/or rendering data are determined at 880 and an inverse visualization transformation is performed at 878 to recreate the bucket containers 876 that would have resulted in those pixels being displayed. An inverse initial transformation may be executed at 874 on the bucket containers 876 to identify the data in the big data database 892 for the user (e.g., and original big data parameter values might be displayed to the user in a drill-down fashion).

Thus, embodiments may provide methods, tools, and/or systems to support highly interactive visualizations of large volumes of datasets. Embodiments may provide innovative interactions and effective technological solutions for visualizing large volumes of datasets across multiple assets and/or businesses (e.g., to explore the life of fleets of assets). Embodiment may use innovative interactive visualization techniques to enable users to investigate thousands of assets (e.g., airplane engines) over their life—which may include tens of thousands of cycles. The interactive tools described herein may give users the ability to quickly ask complex questions about asset dynamics.

Some embodiments described herein may help resolve big data rendering on the screen for the purpose of visual analytics. As opposed to desktop software, some embodiments described herein may use transformations of data values into a dynamic number of buckets on a server/database to be represented by pixels on a client platform. Depending on the size of the underlying dataset and number of available buckets, an individual bucket might be associated with one or more data values. By using multiple transfer functions, embodiments may support different ways to quickly understand different aspects of the underlying data.

Furthermore, through transformation and inverse transformation functions, embodiments may provide the user the means to interactively explore the underlying large data sets. Note that the number of buckets and/or bucket transformation functions can be controlled dynamically based on various factors, for example number of pixels available on screen or the processing capability of hardware. Such an approach (e.g., chunking the data) breaks the overall visualization view on the client side into multiple buckets of information where each bucket stands for a sub-set of data. According to some embodiments, all of these buckets can be calculated and rendered, independent of one another and in parallel. Moreover, some embodiments may provide the flexibility of pushing the bucketing calculations to different parts of the system architecture.

According to some embodiments, a data transformation function is selected to map underlying data into buckets. The system might use, for example, transformation functions like sampling, median, maximum, minimum, and mean. An inverse transformation function may map buckets back into raw data. Note that a bucket transformation function may be selected to map buckets into pixels to generate visualization on the user screen. For example, a visualization transformation functions might convert buckets into line-graphs, scatter-plots, heat maps, etc. Similarly, an inverse transformation function may be selected to map screen pixels back into a bucket. In either case, the number of buckets can be dynamically selected based on: the number of available pixels for the visualization; the processing capability of the hardware; or a user selection.

Some embodiments may support the flexibility of pushing these transformation and inverse-transformation calculations to different parts of the client-server architecture. In one implementation, the data-to-bucket and bucket-to-pixels transformations can be achieved pre-hand and stored in database. In another implementation, the data-to-bucket transformation can be achieved pre-hand and stored in database while the bucket-to-pixel transformation is achieved at the server. In still another implementation, both the data-to-bucket transformation and bucket-to-pixels transformation are achieved at the server. In some implementations, the data-to-bucket transformation is at the server and the bucket-to-pixels transformation is achieved at the client platform. In another implementation, the data-to-bucket and bucket-to-pixels transformations are performed at the client platform. Once the pixels data is available at the client platform, visualization can be rendered as a simple image using the pixel data.

To support seamless user interactions with the visualization, inverse transformations may pull necessary data required by a particular interaction. Furthermore, depending on the selection of transformation function, embodiments may support the flexibility to calculate and render buckets in parallel and asynchronously—thus improving the overall efficiency of the application for large volumes of datasets. Embodiments might be used, for example, to visualize hundreds of time-series, where each series has tens of thousands of data points. Embodiments may let a person essentially visualize multi-million data-points inside a web-browser while still supporting seamless user interactivity. Furthermore, by combining slicing and dicing of big data with bucketing and parallel processing, embodiments may reduce an initial lag time associated with rendering large volumes of datasets.

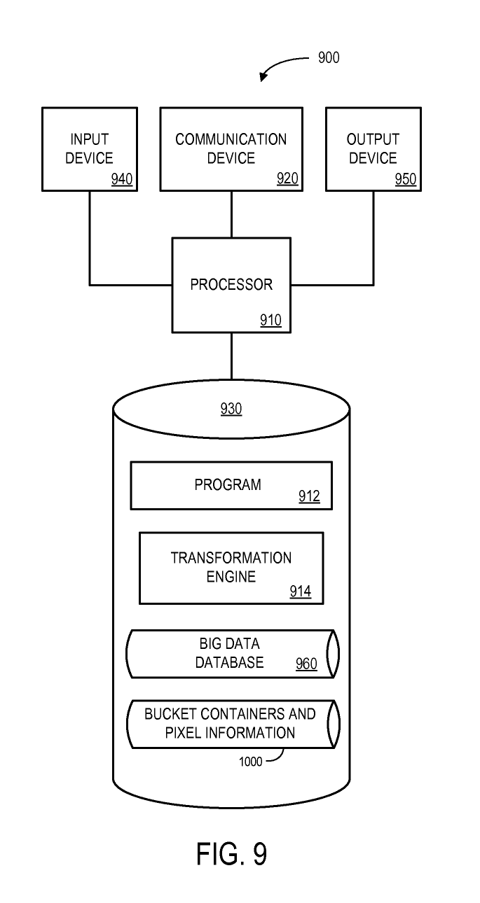

The embodiments described herein may be implemented using any number of different hardware configurations. For example, FIG. 9 illustrates an apparatus 900 that may be, for example, associated with the system 100 of FIG. 1. The apparatus 900 comprises a processor 910, such as one or more commercially available Central Processing Units (CPUs) in the form of one-chip microprocessors, coupled to a communication device 920 configured to communicate via a communication network (not shown in FIG. 9). The apparatus 900 further includes an input device 940 (e.g., a mouse and/or keyboard to enter information about industrial asset operation, user display preferences, etc.) and an output device 950 (e.g., a computer monitor to output visualizations and reports).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 912 and/or a transformation engine 914 for controlling the processor 910. The processor 910 performs instructions of the programs 912, 914, and thereby operates in accordance with any of the embodiments described herein. For example, the processor 910 might access a substantial number of electronic files, including a set of values for a first parameter. A visualization server may receive information from a big data non-relational database, and an initial transformation may be applied to the set of values for the first parameter resulting in a set of bucket containers, each bucket container storing information consolidating a plurality of values for the first parameter. A visualization transformation may then be applied to the bucket containers to create a set of pixel information to be transmitted to and rendered by a client platform.

The programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

As used herein, information may be “received” by or “transmitted” to, for example: (i) the apparatus 900 from another device; or (ii) a software application or module within the apparatus 900 from another software application, module, or any other source.

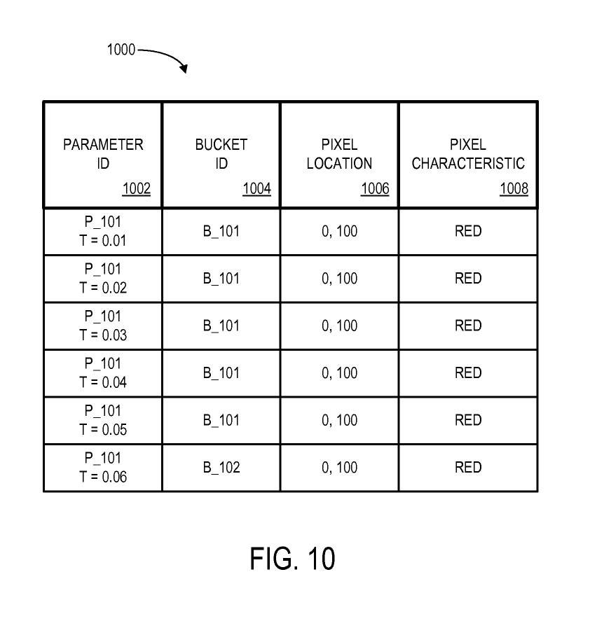

As shown in FIG. 9, the storage device 930 also stores a big data database 960 and a bucket containers and pixel information database 1000. One example of a bucket containers and pixel information database 1000 that may be used in connection with the apparatus 900 will now be described in detail with respect to FIG. 10. The illustration and accompanying descriptions of the database presented herein is exemplary, and any number of other database arrangements could be employed besides those suggested by the figures.

FIG. 10 is a tabular view of a portion of a bucket containers and pixel information database 1000 in accordance with some embodiments of the present invention. The table includes entries associated with a visualization display. The table also defines fields 1002, 1004, 1006, 1008 for each of the entries. The fields specify: a parameter identifier 1002, a bucket identifier 1004, a pixel location 1006, and a pixel characteristic 1008. The information in the database 1000 may be periodically created and updated based on information collection during operation of an industrial asset.

The parameter identifier 1002 might be a unique alphanumeric code identifying 1002 a type of a parameter and a time associated with a value of the parameter. The bucket identifier 1004 may, in accordance with an initial transformation, associated a number of different parameter identifiers with a single bucket container. For example, the first five rows of the database 1000 are all associated with the bucket container “B_101.” The pixel location 1006 and pixel characteristic 1008 may associate multiple bucket containers with a single pixel. For example, as illustrated FIG. 12 all of the rows of the database 1000 are associated with the pixel located at an X, Y location of 0, 100 (which is colored red).

Thus, some embodiments described herein may facilitate a visualization of big data in such a way so as to improve a person's ability to interpret the big data efficiently and/or accurately.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases and apparatus described herein may be split, combined, and/or handled by external systems).

Applicants have discovered that embodiments described herein may be particularly useful in connection with industrial asset management systems, although embodiments may be used in connection other any other type of asset.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a big data non-relational database storing a substantial number of electronic files, including a set of values for a first parameter; and
a server to receive information from the big data non-relational database, wherein:
an initial transformation is applied to the set of values for the first parameter resulting in a set of bucket containers, each bucket container storing information consolidating a plurality of values for the first parameter, and
a visualization transformation is applied to the bucket containers to create a set of pixel information to be transmitted to and rendered by a client platform.

2. The system of claim 1, wherein the initial transformation and visualization transformation are performed at the big data non-relational database and the set of pixel information is stored at the big data non-relational database.

3. The system of claim 1, wherein the initial transformation is performed at the big data non-relational database and the visualization transformation is performed at the server.

4. The system of claim 1, wherein the initial transformation and visualization transformation are performed at the server.

5. The system of claim 1, wherein the number of bucket containers is based at least in part on pixel information associated with the client platform.

6. The system of claim 1, wherein the pixel information is associated with at least one of: (i) a heat map display, (ii) a scatter plot display, (iii) an X-Y axis graph, (iv) a pie chart, and (v) a bar graph display.

7. The system of claim 1, wherein the server is to receive from the client platform a selection of at least one pixel, and further wherein:
an inverse visualization transformation and inverse initial transformation are applied to the at least one selected pixel to determine associated values in the big data non-relational database.

8. The system of claim 1, wherein the set of values for the first parameter in the big data non-relational database are associated with an asset management program.

9. The system of claim 1, wherein the initial transformation is associated with at least one of: (i) a sampling function, (ii) an averaging function, (iii) a minimum value, (iv) a maximum value, and (v) a median value.

10. The system of claim 1, wherein at least some of the bucket containers are processed asynchronously in parallel.

11. The system of claim 1, wherein the visualization transformation is based on at least one of: (i) a user preference, and (ii) a context-based determination.

12. A computer-implemented method, comprising:
accessing, via a big data non-relational database storing a substantial number of electronic files, a set of values for a first parameter;
applying an initial transformation the set of values for the first parameter resulting in a set of bucket containers, each bucket container storing information consolidating a plurality of values for the first parameter; and
applying a visualization transformation to the bucket containers to create a set of pixel information to be transmitted to and rendered by a client platform.

13. The method of claim 12, wherein the initial transformation and visualization transformation are performed at the big data non-relational database and the set of pixel information is stored at the big data non-relational database.

14. The method of claim 12, wherein the initial transformation is performed at the big data non-relational database and the visualization transformation is performed at a server.

15. The method of claim 12, wherein the initial transformation and visualization transformation are performed at a server.

16. The method of claim 1, wherein the number of bucket containers is based at least in part on pixel information associated with the client platform.

17. The method of claim 16, wherein the pixel information is associated with at least one of: (i) a heat map display, (ii) a scatter plot display, (iii) an X-Y axis graph, (iv) a pie chart, and (v) a bar graph display.

18. The method of claim 1, wherein the server is to receive from the client platform a selection of at least one pixel, and further wherein:
an inverse visualization transformation and inverse initial transformation are applied to the at least one selected pixel to determine associated values in the big data non-relational database.

19. A non-transitory, computer-readable medium storing instructions that, when executed by a computer processor, cause the computer processor to perform a method, the method comprising:
accessing, via a big data non-relational database storing a substantial number of electronic files, a set of values for a first parameter;
applying an initial transformation the set of values for the first parameter resulting in a set of bucket containers, each bucket container storing information consolidating a plurality of values for the first parameter; and
applying a visualization transformation to the bucket containers to create a set of pixel information to be transmitted to and rendered by a client platform.

20. The medium of claim 19, wherein the initial transformation and visualization transformation are performed at the big data non-relational database and the set of pixel information is stored at the big data non-relational database.

21. The medium of claim 19, wherein the initial transformation is performed at the big data non-relational database and the visualization transformation is performed at a server.

22. The medium of claim 19, wherein the initial transformation and visualization transformation are performed at a server.
